(19) United States
(12) Patent Application Publication
(10) Pub. No.: US 2021/0008834 A1
(43) Pub. Date: Jan. 14, 2021

(54) STRUCTURE OF INSULATING TEMPERATURE CONDUCTIVITY OF INFLATABLE BED

(71) Applicant: Tsung Hsi Liu, Yilan County (TW)

(72) Inventor: Tsung Hsi Liu, Yilan County (TW)

(21) Appl. No.: 16/507,031

(22) Filed: Jul. 10, 2019

(51) Int. Cl. B32B 7/08; B32B 5/02; B32B 5/18; B32B 5/24; A47C 27/18; A47C 27/08

(52) U.S. Cl. CPC B32B 7/08; B32B 5/022; B32B 5/18; B32B 2266/0278; A47C 27/18; A47C 27/081; B32B 5/245

(57) ABSTRACT

A structure of insulating temperature conductivity of an inflatable bed contains: a first layer, a second layer, an inner air chamber, multiple connection straps, multiple temperature stoppers, and at least one temperature insulation layer. The inner air chamber is defined between the first layer and the second layer. The multiple connection straps are separately connected between the first layer and the second layer. The multiple temperature stoppers are accommodated in the multiple connection straps respectively, and the at least one temperature insulation layer is filled between the first layer and the second layer.

### FIELD OF THE INVENTION

The present invention relates to a structure of insulating temperature conductivity of an inflatable bed which insulates air circulation in the inflatable bed so as to avoid temperature conductivity further.

### BACKGROUND OF THE INVENTION

A conventional inflatable bed is applied to insulate a temperature of a ground conducting to user's body and to enhance using comfort.

However, the temperature of the ground cannot be stopped by the conventional inflatable bed effectively. In addition, a weight of the conventional inflatable bed is too heavy to be portable easily.

The present invention has arisen to mitigate and/or obviate the afore-described disadvantages.

### SUMMARY OF THE INVENTION

The primary aspect of the present invention is to provide a structure of insulating temperature conductivity of an inflatable bed which insulates air circulation in the inflatable bed so as to avoid temperature conductivity further.

Another aspect of the present invention is to provide a structure of insulating temperature conductivity of an inflatable bed which when the inflatable bed is placed on a ground, a low temperature of the ground is insulated below the temperature stoppers and the temperature insulation layer so that user(s) lie on the inflatable bed thermally.

To obtain above-mentioned aspect, a structure of insulating temperature conductivity of an inflatable bed provided by the present invention contains: a first layer, a second layer, an inner air chamber, multiple connection straps, multiple temperature stoppers, and at least one temperature insulation layer.

The inner air chamber is defined between the first layer and the second layer.

The multiple connection straps are separately connected between the first layer and the second layer.

The multiple temperature stoppers are accommodated in the multiple connection straps respectively, and the at least one temperature insulation layer is filled between the first layer and the second layer.

Preferably, the at least one temperature insulation layer is made of polyurethane (PU) foam/aerogel composite materials

Preferably, the temperature stoppers are made of polyurethane (PU) foam material.

Preferably, the temperature stoppers are made of polyurethane (PU) foam aerogel composite materials.

Preferably, a non-woven layer is fixed on a top of the at least one temperature insulation layer.

### BRIEF DESCRIPTION OF THE DRAWINGS

FIG. 1 is a perspective view showing the assembly of a structure of insulating temperature conductivity of an inflatable bed according to a preferred embodiment of the present invention.

FIG. 2 is a cross sectional view showing the assembly of a part of the structure of insulating the temperature conductivity of the inflatable bed according to the preferred embodiment of the present invention.

### DETAILED DESCRIPTION OF THE PREFERRED EMBODIMENTS

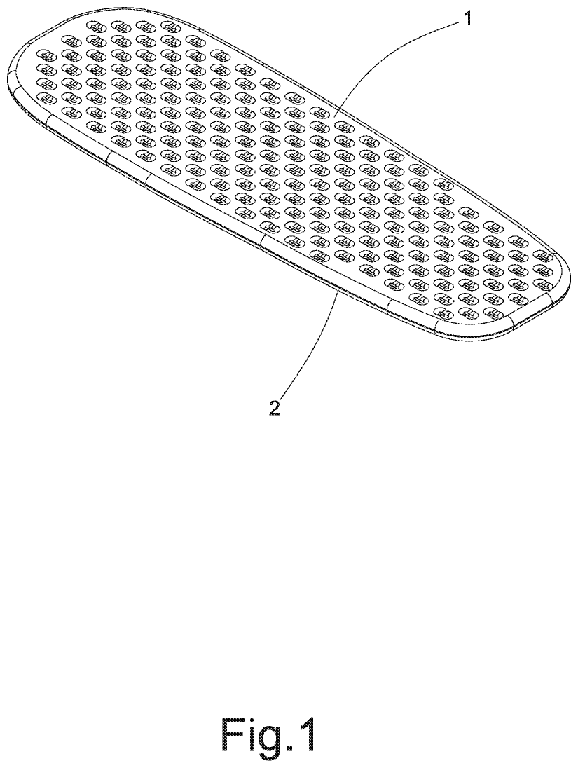

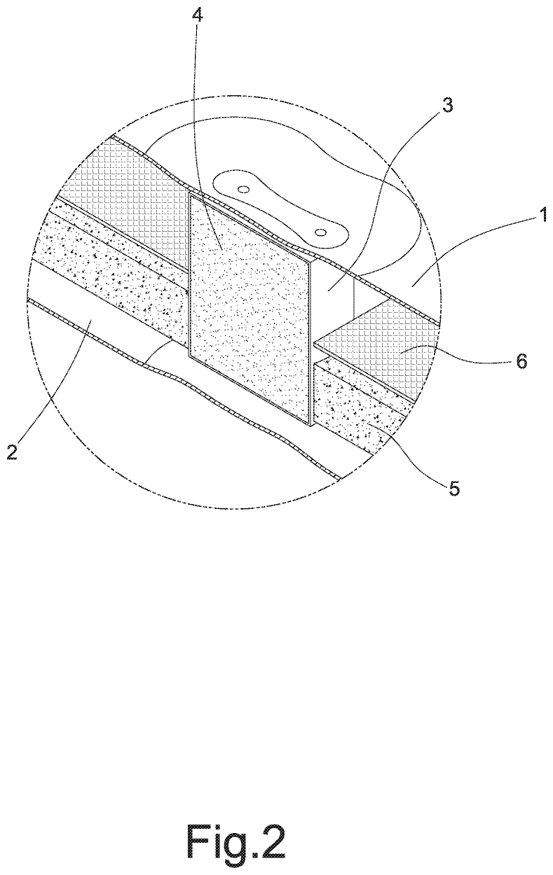

With reference to FIGS. 1-2, a structure of insulating temperature conductivity of an inflatable bed according to a preferred embodiment of the present invention comprises: a first layer 1, a second layer 2, an inner air chamber defined between the first layer 1 and the second layer 2 so as to inflate air into the air chamber, multiple connection straps 3 separately connected between the first layer 1 and the second layer 2 so as to flatten the inflatable bed after inflating air into the air chamber, and multiple temperature stoppers 4 accommodated in the multiple connection straps 3 respectively so as to insulate air circulation and temperature conductivity, and at least one temperature insulation layer 5 filled between the first layer 1 and the second layer 2, wherein the at least one temperature insulation layer 5 is made of polyurethane (PU) foam/aerogel composite materials so as to insulate air circulation and temperature conductivity.

In another embodiment, a non-woven layer 6 is fixed on a top of the at least one temperature insulation layer 5 so as to insulate temperature conductivity.

The temperature stoppers 4 are made of polyurethane (PU) foam material or polyurethane (PU) foam/aerogel composite materials.

When the inflatable bed is placed on a ground, a low temperature of the ground is insulated below the temperature stoppers 4 and the temperature insulation layer 5 so that user(s) lie on the inflatable bed thermally.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A structure of insulating temperature conductivity of an inflatable bed comprising:
a first layer, a second layer, an inner air chamber defined between the first layer and the second layer, multiple connection straps separately connected between the first layer and the second layer, and multiple temperature stoppers accommodated in the multiple connection straps respectively, and at least one temperature insulation layer filled between the first layer and the second layer.

2. The structure as claimed in claim 1, wherein the at least one temperature insulation layer is made of polyurethane (PU) foam/aerogel composite materials

3. The structure as claimed in claim 1, wherein the temperature stoppers are made of polyurethane (PU) foam material.

4. The structure as claimed in claim 2, wherein the temperature stoppers are made of polyurethane (PU) foam material.

5. The structure as claimed in claim 1, wherein the temperature stoppers are made of polyurethane (PU) foam/aerogel composite materials.

6. The structure as claimed in claim 2, wherein the temperature stoppers are made of polyurethane (PU) foam/aerogel composite materials.

7. The structure as claimed in claim 1, wherein a non-woven layer is fixed on a top of the at least one temperature insulation layer.

8. The structure as claimed in claim 1, wherein one or more temperature insulation layers are filled between the first layer and the second layer.
